(19) United States
(12) Patent Application Publication
(10) Pub. No.: US 2004/0125512 A1
(43) Pub. Date: Jul. 1, 2004

(54) Thin-film magnetic head with electrostatic damage protection and magnetic recording and playback apparatus

(75) Inventor: Katsuya Kikuiri, Niigata-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/626,324

(22) Filed: Jul. 23, 2003

(30) Foreign Application Priority Data
Jul. 25, 2002 (JP) 2002-216900

(51) Int. Cl. G11B 5/39

(52) U.S. Cl. 360/313

(57) ABSTRACT

A thin-film magnetic head assembly includes a core block, a magnetoresistive element disposed adjacent to an insulating layer inside the core block, a base plate on which the core block is mounted, an insulating junction substrate mounted on at least one surface of the base plate, and lines connecting the magnetoresistive element to terminals disposed on the junction substrate. The relationship C_{PWB}/C_{MR}<1.5 is satisfied, wherein C_{MR} is the capacitance of the core block including the magnetoresistive element, and C_{PWB} is the capacitance of a section including the junction substrate and the base plate.

### BACKGROUND OF THE INVENTION

1. Field of the Invention

The present invention relates to a thin-film magnetic head assembly which includes a core block with a built-in magnetoresistive element and in which the core block is mounted on a base plate.

2. Description of the Related Art

With respect to magnetic heads for VTRs, tape storage devices, etc., as the recording density improves and the signal recording format becomes digitized, track widths are narrowed year by year. Under such circumstances, in order to decrease track widths, thin-film magnetic heads including thin-film coils and magnetoresistive elements have been used as helical-scan magnetic heads for VTRs, etc.

FIG. 12 is a perspective view which shows a structure of a thin-film magnetic head of this type, and FIG. 13 is a sectional view which shows a key part of the structure. In a thin-film magnetic head A shown in FIGS. 12 and 13, core halves 101 and 102 are bonded together with a built-in layer 103 and an adhesive layer 104 therebetween, and a write head (inductive head) 108 and a read head 109 are included in the built-in layer 103 between the core halves 101 and 102. Although an example of the structure including both the write head 108 and the read head 109 is shown, a thin-film magnetic head including the read head 109 only is also used.

In the thin-film magnetic head A, a long, convex sliding surface 105 which relatively slides over a magnetic recording medium, such as a magnetic tape, is formed on the tops of the core halves 101 and 102.

As shown in FIG. 13, on the core half 102 composed of alumina-titanium carbide, an insulating layer 110, a lower shielding layer 111, a lower gap layer 112, a magnetoresistive element 113, an electrode layer 115, and an upper gap layer 116 are deposited to form the read head 109, and further thereon, an upper shielding layer 120A, an insulating layer 120B, a gap layer 121, a coil layer 122 which is spiral when viewed in plan, an insulating layer 123 covering the coil layer 122, an upper core layer 125, and an insulating layer 126 are deposited to form the write head 108.

A conductor 128 is disposed on the upper core layer 125, the conductor 128 penetrating the insulating layer 126 and extending to the upper surface of the insulating layer 126, and a pad 129 which is connected to the conductor 128 is formed on the insulating layer 126. A conductor 137 is also disposed, the conductor 137 extending from the electrode layer 115 and penetrating the read head 109, the write head 108, and the insulating layer 126 and extending to the upper surface of the insulating layer 126, and a pad 138 is provided on the tip of the conductor 137 on the upper surface of the insulating layer 126.

Additionally, a section in which the magnetoresistive element 113 is located adjacent to the sliding surface 105 is referred to as a read gap section, and a section in which the gap layer 121 sandwiched between the upper shielding layer 120A and the upper core layer 125 is located adjacent to the sliding surface 105 is referred to as a write gap section.

As shown in FIGS. 14 and 15, the thin-film magnetic head A having the structure described above is, for example, fixed on the leading end of a metal base plate 130, and a thin-film magnetic head assembly is thereby formed. The thin-film magnetic head assembly is individually mounted on a predetermined position of the periphery of a rotary cylinder of a magnetic recording and playback apparatus, such as a VTR, so that magnetic information is written into or read from a magnetic tape which is relatively slid over the sliding surface while being taken up by the rotary cylinder.

When the thin-film magnetic head A is mounted on the base plate 130 shown in FIG. 14, since the thin-film magnetic head A must be connected to the electrical circuit of the magnetic recording and playback apparatus, usually, a junction substrate 131 composed of a resin, such as epoxy, is mounted on a surface of the base plate 130, and a predetermined number of terminals 132 are formed on the junction substrate 131. The terminals 132 and the pads 129 and 138 are connected to each other with lines 135, such as wire bonding lines, and the terminals 132 are connected to the electrical circuit of the rotary cylinder of the magnetic recording and playback apparatus with lines, such as wires, (not shown in the drawing).

However, in the thin-film magnetic head A, as shown in FIG. 13, the read head 109 and the write head 108 are disposed between the insulating layer 110 and the insulating layer 126. In these heads, each of the lower gap layer 112, the upper gap layer 116, and the gap layer 121 is composed of an insulating material, and the magnetoresistive element 113 is used in the read head 109. Consequently, the section including the magnetoresistive element 113 has a capacitance while being sandwiched between various insulating layers, i.e., a so-called capacitor structure is formed. Since the junction substrate 131, which is mounted on the surface of the metal base plate 130, is composed of a resin and is electrically connected to the thin-film magnetic head A by the lines 135, a small capacitance is considered to be produced by the base plate 130, the junction substrate 131, and the lines.

If electrostatic charges are applied, for some reason, to the base plate 130 provided with the thin-film magnetic head A, the junction substrate 131, and the lines 135, and if the base plate 130 is brought into contact with a human body or a grounded element, stored static electricity is discharged, and abnormal current flows in the magnetoresistive element 113 to generate heat. As a result, the magnetoresistive element 113 may be damaged by electrostatic discharge or magnetic properties may be degraded.

### SUMMARY OF THE INVENTION

It is an object of the present invention to provide a thin-film magnetic head provided with a magnetoresistive element, which prevents electrostatic damage or degradation of magnetic properties of the magnetoresistive element due to electrostatic discharge.

In one aspect of the present invention, a thin-film magnetic head assembly includes a core block provided with a sliding surface which slides over a medium, the core block including a magnetoresistive element disposed adjacent to an insulating layer; a base plate on which the core block is mounted; an insulating junction substrate mounted on at least one surface of the base plate; and lines connecting the magnetoresistive element in the core block to terminals disposed on the junction substrate. The relationship C_{PWB}/C_{MR}<1.5 is satisfied, wherein C_{MR} is the capacitance of the core block including the magnetoresistive element, and C_{PWB} is the capacitance of a section including the junction substrate and the base plate.

The magnetoresistive element is disposed adjacent to the insulating layer inside the core block and is surrounded by the core block. Consequently, when the entire core block is charged, there may be a case in which abnormal current flows into the magnetoresistive element.

The junction substrate composed of a resin is mounted on the base plate provided with the core block, and each of the junction substrate and the core block has a capacitance. Consequently, when charged, there may be a case in which abnormal current resulting from the charges of the core block and the charges of the junction substrate flows into the magnetoresistive element.

However, when the relationship C_{PWB}/C_{MR}<1.5 is satisfied, since the capacitance of the section including the junction substrate and the base plate is not very large, the current that may flow into the magnetoresistive element due to electrostatic charges can be decreased. Consequently, damage to the magnetoresistive element due to electrostatic discharge can be prevented, and the incidence of degradation due to electrostatic discharge can also be decreased, thus contributing to a reduction in the defective rate.

In the thin-film magnetic head assembly of the present invention, preferably, the magnetoresistive element is disposed between a plurality of insulating layers inside the core block.

When the magnetoresistive element is sandwiched between the insulating layers, a capacitance is easily produced by the magnetoresistive element and the insulating layers around the magnetoresistive element. In such a structure, it is also possible to reliably prevent degradation or damage of the magnetoresistive element due to static electricity.

In the thin-film magnetic head assembly of the present invention, preferably, the total of the capacitance C_{MR} of the core block including the magnetoresistive element and the capacitance C_{PWB} of the section including the junction substrate and the base plate is 5 pF or less.

In the thin-film magnetic head assembly of the present invention, more preferably, the total of the capacitance C_{MR} of the core block including the magnetoresistive element and the capacitance C_{PWB} of the section including the junction substrate and the base plate is 1 to 5 pF.

If the total of the capacitance of the core block including the magnetoresistance element and the capacitance of the section including the junction substrate and the base plate is in the range described above, the magnetoresistive element is unlikely to be damaged by electrostatic discharge, and the properties of the magnetoresistive element are not substantially degraded by electrostatic discharge.

In another aspect of the present invention, a magnetic recording and playback apparatus includes any one of the thin-film magnetic head assemblies described above and a rotary cylinder, the apparatus being mounted in a recess formed in the periphery of the rotary cylinder.

In the magnetic recording and playback apparatus of the present invention, by setting the total of the capacitance C_{MR} of the core block including the magnetoresistive element and the capacitance C_{PWB} of the section including the junction substrate and the base plate at 5 pF or less, the magnetoresistive element is prevented from being damaged by electrostatic discharge, and the magnetic properties of the magnetoresistive element are not substantially degraded. Consequently, it is possible to provide a highly reliable magnetic recording and playback apparatus.

In the thin-film magnetic head assembly of the present invention, preferably, the core block comprises a pair of core halves, the core halves being joined together, and a built-in layer is disposed at the junction between the core halves. The built-in layer includes the magnetoresistive element, an electrode layer connected to the magnetoresistive element, insulating layers, and shielding layers, the insulating layers and the shielding layers sandwiching the magnetoresistive element and the electrode layer. The electrode layer is connected to pads disposed outside the built-in layer, and the lines connected to the terminals of the junction substrate are connected to the pads. In the core block, a capacitance is produced by the insulating layers and the magnetoresistive element disposed between the insulating layers.

In the magnetoresistive element sandwiched between the insulating layers included in the built-in layer sandwiched between the core halves, a capacitance is definitely produced. A capacitance is also definitely produced by the base plate, the resin junction substrate and the lines. In the construction described above, charges are easily accumulated in the magnetoresistive element, and when charged, damage or degradation is highly likely to be caused by electrostatic discharge. The structure of the present invention can overcome the possibility of damage or degradation due to electrostatic discharge.

### BRIEF DESCRIPTION OF THE DRAWINGS

FIG. 1 is a plan view of a thin-film magnetic head assembly including a core block mounted on a base plate in a first embodiment of the present invention;

FIG. 2 is a back view of the thin-film magnetic head assembly in the first embodiment of the present invention;

FIG. 3 is a plan view showing a state in which thin-film magnetic head assemblies including core blocks mounted on base plates are fitted to a rotary cylinder in accordance with the present invention;

FIG. 4 is a perspective view of a thin-film magnetic head assembly including a core block mounted on a base plate in a second embodiment of the present invention;

FIG. 5 is a back view of the thin-film magnetic head assembly in the second embodiment of the present invention;

FIG. 6 is a graph showing output characteristics in an example of a thin-film magnetic head assembly of the present invention;

FIG. 7 is a graph showing output characteristics in another example of a thin-film magnetic head assembly of the present invention;

FIG. 8 is a graph showing output characteristics in a comparative example of a thin-film magnetic head assembly;

FIG. 9 is a graph showing output characteristics in another comparative example of a thin-film magnetic head assembly of the present invention;

FIG. 10 is a graph showing a relationship between the microtrack profile defective rate and the capacitance ratio (C_{PWB}/C_{MR});

FIG. 11 is a graph showing a relationship between the microtrack profile defective rate and the total capacitance (C_{PWB}+C_{MR});

FIG. 12 is a perspective view showing a structure of a thin-film magnetic head;

FIG. 13 is an enlarged sectional view which shows a key part of the structure shown in FIG. 12;

FIG. 14 is a plan view of a conventional thin-film magnetic head assembly including a thin-film magnetic head mounted on a base plate; and

FIG. 15 is a back view of the thin-film magnetic head assembly shown in FIG. 14.

### DESCRIPTION OF THE PREFERRED EMBODIMENTS

The embodiments of the present invention will be described below with reference to the drawings. It is to be understood that the present invention is not limited to the embodiments. In the drawings, the individual elements are shown at various scales so as to be easily viewable.

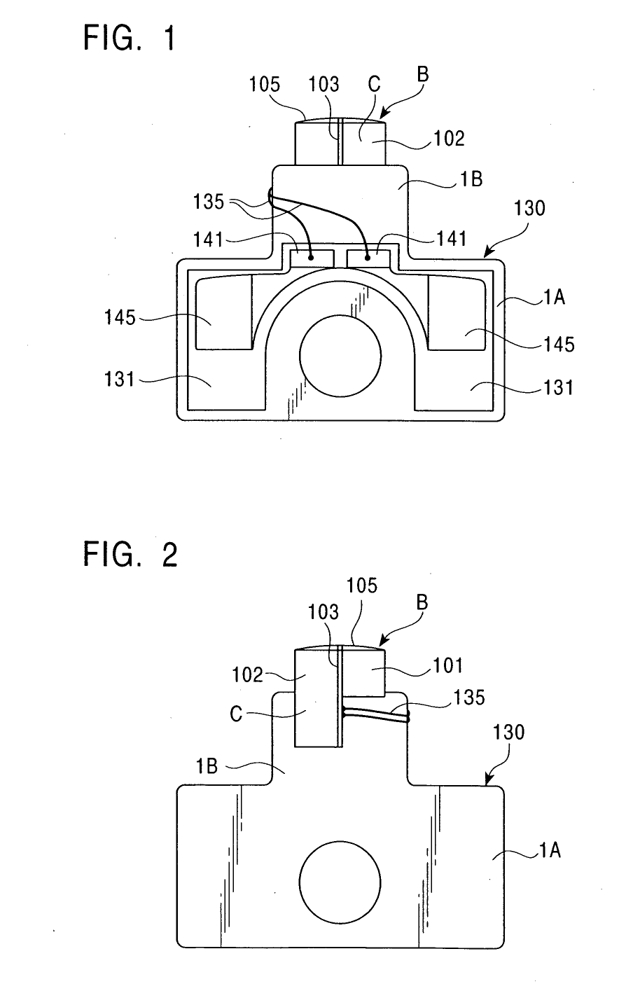

FIGS. 1 and 2 show a thin-film magnetic head assembly in which a thin-film magnetic head B is mounted on a base plate 130 of a rotary cylinder of a magnetic recording apparatus, such as a VTR, in a first embodiment of the present invention.

The thin-film magnetic head B includes an L-shaped core block C in which the side faces of block-shaped core halves 101 and 102 are bonded together with a built-in layer 103 therebetween. The core block C is fixed and bonded to the base plate 130 such that the sides of the core halves 101 and 102 having large areas are made to abut against the leading end of the convex base plate 130, and one end of each of the core halves 101 and 102 slightly protrudes from the end of the base plate 130.

The core halves 101 and 102 are composed of a ceramic material, such as calcium titanate (CaTiO₃) or alumina-titanium carbide (Al₂O₃+TiC), or a magnetic material, such as ferrite, with high abrasion resistance.

A surface of the thin-film magnetic head B protruding from the base plate 130 is formed into a long, convex surface, which is a sliding surface 105.

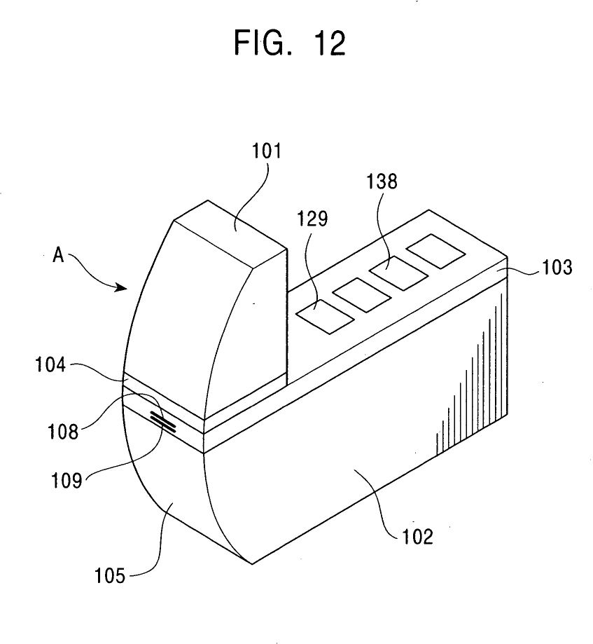

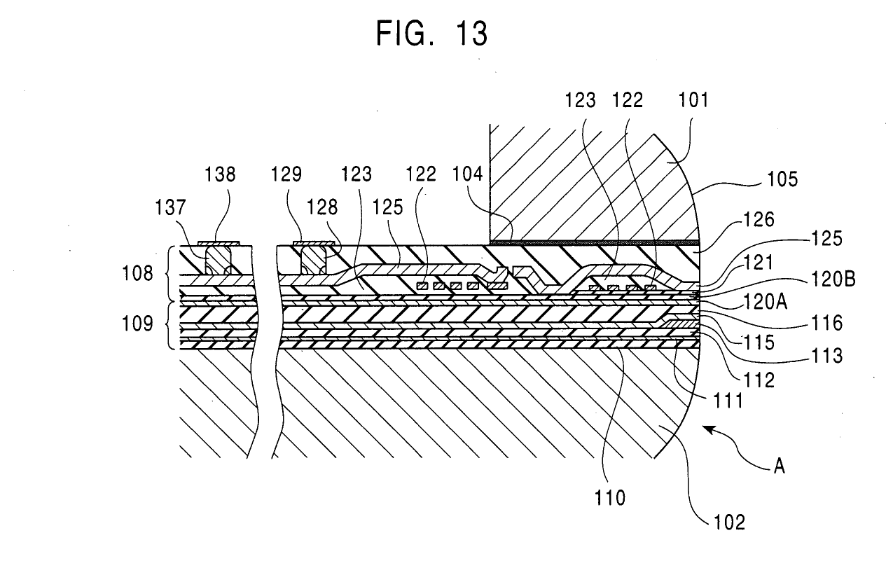

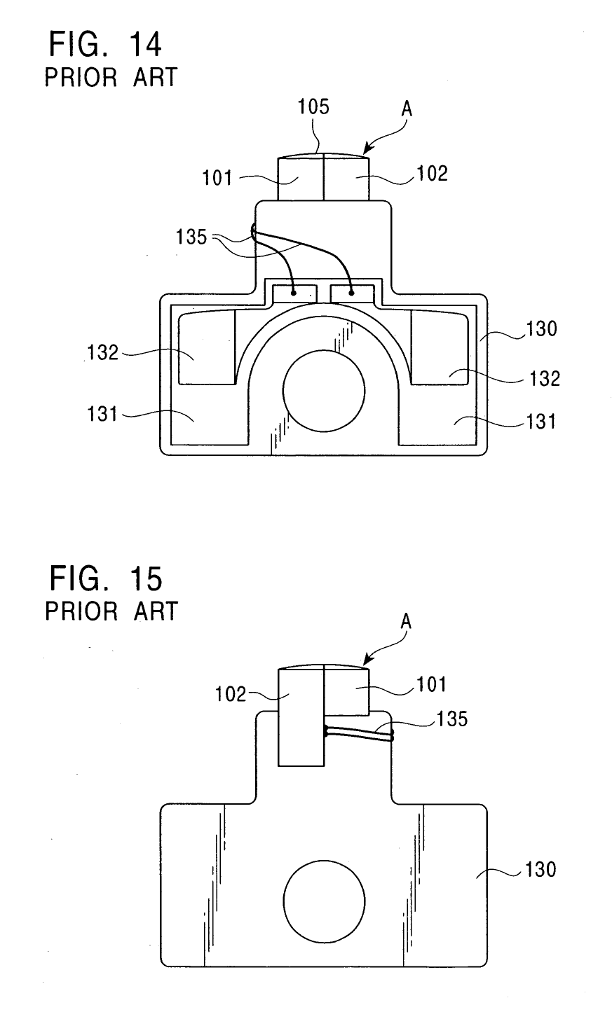

The built-in layer 103 includes the write head (inductive head) 108 and the read head 109, which have been described with reference to FIGS. 12 and 13. Additionally, in the present invention, the thin-film magnetic head B may be a read only head including the read head 109 only. Although the upper shielding layer 120A and the insulating layer 120B are formed separately in the structure described with reference to FIG. 13, the upper shielding layer 120A and the insulating layer 120B may be combined to form a single layer.

The magnetoresistive element 113 of the read head 109 is composed of an MR element having a structure including a nonmagnetic film sandwiched between a ferromagnetic film and a magnetoresistive film, or a spin-valve giant magnetoresistive multilayer element. When a leakage magnetic field from a magnetic recording medium, such as a magnetic tape, is applied to the magnetoresistive element 113 in a state in which a sensing current is applied from the electrode layer 115, the resistance is changed.

In the write head 108, when a recording current is applied to the coil layer 122, which is spiral when viewed in plan, a magnetic field is applied from the pole tip section including the upper gap layer 116 and upper core layer 125 sandwiching the coil layer 122, and thereby, a magnetic signal is recorded into a magnetic recording medium, such as magnetic tape. The magnetic recording signal can be read by a change in resistance of the magnetoresistive element 113.

The size of the core half 101 is approximately half of that of the core half 102. A predetermined number of pads, for example, 3 to 4 pads, in addition to the pads 129 and 138 shown in FIG. 13, are formed on the built-in layer 103 exposed to the side of the larger core half 102.

The ends of the lines 135, such as wire bonding lines, are electrically connected to the pads by soldering or the like.

The base plate 130 is composed of a metal, such as brass, and is convexed, including a rectangular body 1A and a small, attached plate 1B protruding from the body 1A. The core block C is fixed on the leading end of the attached plate 1B. A junction substrate (printed wiring board) 131, which is U-shaped when viewed in plan, composed of an epoxy resin or the like, is fixed on one surface of the body 1A. The other ends of the lines 135 are electrically connected by soldering or the like to terminals 141 which are disposed on the junction substrate adjacent to the attached plate 1B. Furthermore, terminal pads 145 for external connection use are disposed on the surface of the junction substrate 131 corresponding to the body 1A, the terminal pads 145 being connected to the terminals 141.

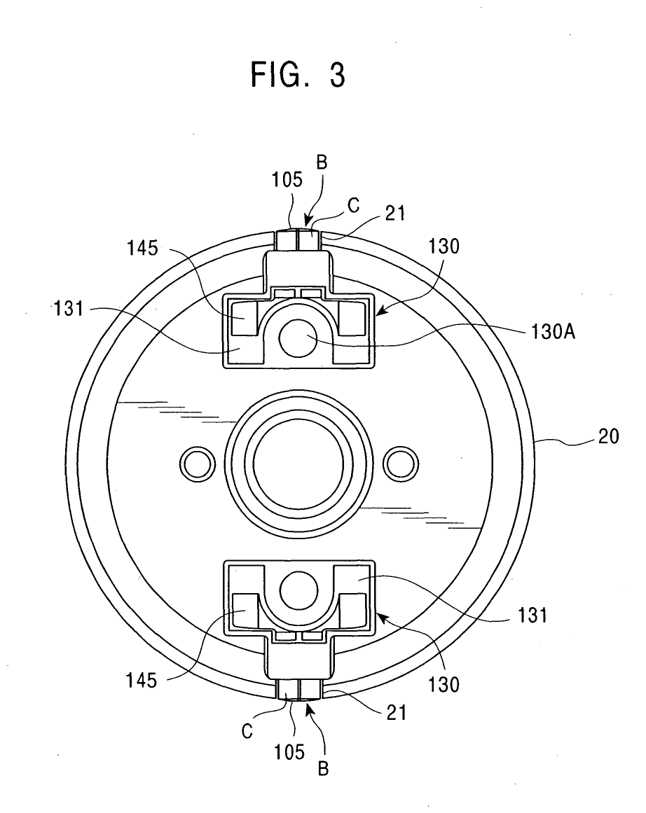

FIG. 3 shows a state in which base plates 130 provided with core blocks C including thin-film magnetic heads B are fixed to a rotary cylinder 20 of a magnetic recording and playback apparatus. In FIG. 3, the lines 135 are not shown.

A plurality of recesses 21 are formed at predetermined positions in the periphery of the rotary cylinder 20. The base plate 130 is fixed into each recess 21 so that the leading ends of the base plate 130 and the core block C are fitted into the recess 21 and the sliding surface 105 of the core block C aligns with the periphery of the rotary cylinder 20. In order to fix the base plate 130 into the recess 21, for example, a bolt is screwed into a screw hole provided on the rotary cylinder 20 through a clearance hole 130A provided in the center of the base plate 130.

In the thin-film magnetic head B, the magnetoresistive element 113 provided inside the core block C has the structure shown in FIG. 13. That is, the read head 109 and the write head (inductive head) 108 are disposed between the insulating layer 110 and the insulating layer 126. In these heads, each of the lower gap layer 112, the upper gap layer 116, and the gap layer 121 is composed of an insulating material, and the magnetoresistive element 113 is used in the read head 109. Consequently, the section including the magnetoresistive element 113 has a capacitance while being sandwiched between various insulating layers, i.e., a so-called capacitor structure is formed.

In the present invention, preferably, the relationship C_{PWB}/C_{MR}<1.5 is satisfied, wherein C_{MR} is a capacitance of a section including the core halves 101 and 102, the adhesive layer 104, the built-in layer 103, and the thin-film magnetic head B, and C_{PWB} is a capacitance of a section including the base plate 130 and the junction substrate 131. The total of the capacitance C_{MR} and the capacitance C_{PWB} is preferably 5 pF or less, and more preferably 1 to 5 pF.

In order to set the capacitances in the ranges described above, the read head 109 may be formed with the following construction. That is, the core halves 101 and 102 are composed of alumina-titanium carbide. The insulating layer 110 is composed of Al₂O₃ or SiO₂ with a thickness of 2 μm. The lower shielding layer 111 is composed of a soft magnetic material, such as permalloy, with a thickness of 2.5 μm. The lower gap layer 112 is composed of Al₂O₃ or SiO₂ with a thickness of 0.07 μm and an area of approximately 300 μm². The magnetoresistive element 113 includes a soft adjacent layer (SAL) for producing a bias, which is composed of CoZrNb, NiFeNb, or the like, a magnetic separation layer composed of Ta or the like, and an MR layer composed of NiFe, with a total thickness of 0.033 μm. The electrode layer 115 is composed of a conductive material, such as Cu, with a thickness of 2 to 3 μm and a total area of 78,000 μm². The upper gap layer 116 is composed of Al₂O₃ or SiO₂ with a thickness of 0.1 μm.

The write head 108 may be formed with the following construction. That is, the upper shielding layer 120A is composed of a soft magnetic material, such as permalloy, with a thickness of 2.5 μm and an area of 1,400 μm². The gap layer 121 is composed of Al₂O₃ or SiO₂ with a thickness of 0.2 μm. The coil layer 122, which is spiral when viewed in plan, is composed of a conductive material, such as Cu, with a thickness of 3 μm, or 2 to 3 μm, and a total area of 85,000 μm². The insulating layer 123 is composed of Al₂O₃ or SiO₂ with a thickness of 0.5 to 0.8 μm. The upper core layer 125 is composed of a soft magnetic material, such as permalloy, with a thickness of 3 to 4 μm. The insulating layer 126 is composed of Al₂O₃ or SiO₂ with a thickness of 10 to 15 μm.

The conductor 128 may be composed of a conductive material, such as Cu, and the pad 129 may be composed of a conductive material, such as Pt, Au, or Cu, with a thickness of 2 to 3 μm. The conductor 137 may be composed of a conductive material, such as Cu, and the pad 138 may be composed of a conductive material, such as Pt, Au, or Cu, with a thickness of 2 to 3 μm. The total area of the pads 129 and 138 may be 34,000 μm².

By employing the structure described above, it is possible to set the capacitance C_{MR} of the core block C provided with the thin-film magnetic head B including the magnetoresistive element 113 at approximately 1.5 to 3 pF.

By employing the following construction, it is possible to set the capacitance C_{PWB} of the section including the junction substrate 131 and the base plate 130 at approximately 1.3 to 1.7 pF. That is, the base plate 130 is composed of brass. The junction substrate 131 is composed of an epoxy resin with a thickness of 0.2 mm, and the area of the conductive section is set at approximately 4.6 mm². The junction substrate 131 is bonded to the base plate 130.

As the junction substrate 131, a flexible printed circuit board (FPC) composed of a polyimide, or a glass epoxy substrate may be used. For example, a FPC includes an adhesive layer with a thickness of 0.05 mm, a glass epoxy layer with a thickness of 0.15 mm, an adhesive layer with a thickness of 0.05 mm, a polyimide layer with a thickness of 0.013 mm, an adhesive layer with a thickness of 0.05 mm, a copper foil with a thickness of 0.018 mm, and a protective resist layer. For example, a glass epoxy substrate includes an adhesive layer with a thickness of 0.05 mm, a glass epoxy layer with a thickness of 0.2 to 0.3 mm, an adhesive layer with a thickness of 0.05 mm, a copper foil with a thickness of 0.018 mm, and a protective resist layer. In these substrates, by adjusting the thicknesses of the reinforcing members, the adhesive layers, or the glass epoxy layers, the capacitance can be controlled in a proper range.

When the relationship C_{PWB}/C_{MR}<1.5 is satisfied, since the capacitance of the section including the junction substrate 131 and the base plate 130 is less than 1.5 times the capacitance of the core block, which is not very large, the current that may flow into the magnetoresistive element 113 due to electrostatic charges can be decreased. Consequently, electrostatic degradation or electrostatic damage of the magnetoresistive element 113 due to electrostatic discharge can be reliably prevented. Herein, the electrostatic degradation means that a concave distortion occurs in the output characteristics of the magnetoresistive element 113 as will be described later.

By setting the total of the capacitance C_{MR} and the capacitance C_{PWB} at 5 pF or less, the absolute value of electrostatic charge when charged can be minimized, and the current that may flow into the magnetoresistive element 113 due to electrostatic charges can be decreased. Preferably, the total capacitance of the section including the magnetoresistive element B and the section including the junction substrate 131 is as small as possible. Structurally, it is not possible to set the total capacitance at zero, and it is difficult to set the total capacitance at less than 1 pF. Consequently, the total capacitance of the section including the magnetoresistive element B and the section including the junction substrate 131 is 1 pF or more.

By satisfying the relationship described above, electrostatic damage to the magnetoresistive element 113 can be prevented, and electrostatic degradation is also prevented reliably.

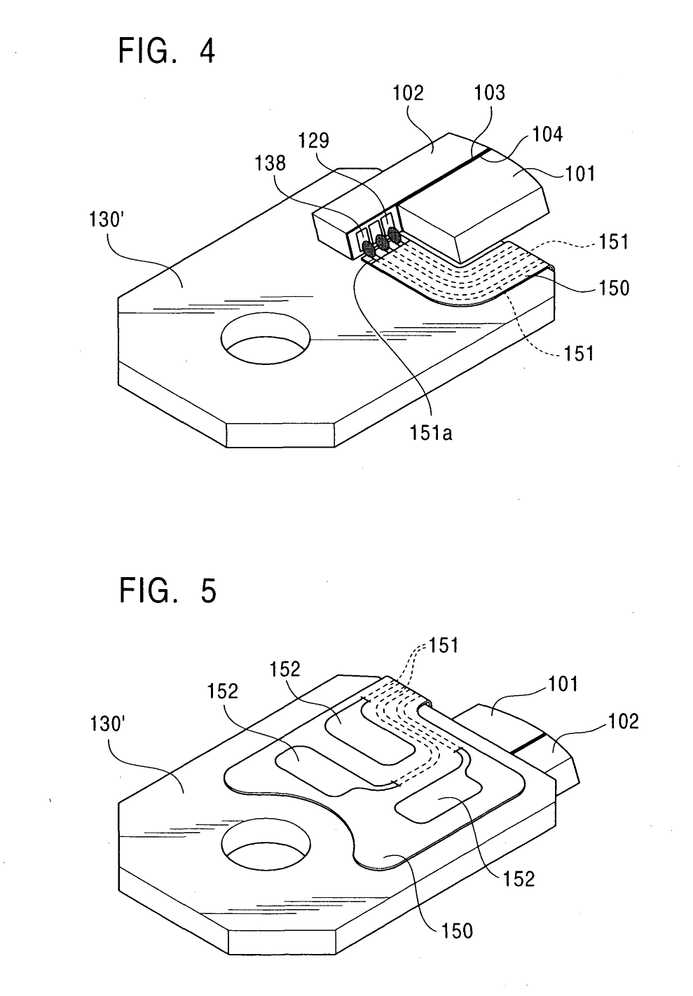

FIGS. 4 and 5 show a thin-film magnetic head assembly in a second embodiment of the present invention. In the thin-film magnetic head assembly, the thin-film magnetic head B is mounted on a rectangular base plate 130′, and a flexible printed circuit board 150 is provided on one surface of the base plate 130′ so as to be folded toward the other surface of the base plate 130′. In this embodiment, the present invention is applied to the thin-film magnetic head assembly with such a structure.

In the second embodiment, the lines 135, which are used in the first embodiment, are not individually provided. The ends 151a of a plurality of lines 151 provided on the flexible printed circuit board 150 are connected to the pads 129 and 138 by soldering or the like. The lines 151 are extended to the other surface of the base plate 130′, and terminals 152 for the lines 151 are provided on the flexible printed circuit board 150. In such a structure, the capacitances can be set as in the first embodiment. That is, the capacitance of the flexible printed circuit board 150 and the base place 130′ is considered as the capacitance C_{PWB}, and the capacitance of the core block C is considered as the capacitance C_{MR}.

### EXAMPLES

A plurality of thin-film magnetic head assemblies were produced using the construction described with reference to FIGS. 12 and 13. That is, each thin-film magnetic head assembly included core halves 101 and 102 (alumina-titanium carbide), an insulating layer 110 (Al₂O₃), a lower shielding layer. 111 (permalloy), a lower gap layer 112 (Al₂O₃), a magnetoresistive element 113 (SAL layer+magnetic separation layer+MR layer), an electrode layer 115 (Cu), an upper gap layer 116 (Al₂O₃), an upper shielding layer 120A (permalloy), a gap layer 121 (Al₂O₃), a coil layer 122 (Cu), an insulating layer 123 (Al₂O₃), an upper core layer 125 (permalloy), an insulating layer 126 (Al₂O₃), a conductor 128 (Cu), a pad 129 (Au), a conductor 137 (Cu), and a pad 138 (Au). A brass base plate 130 and an epoxy junction substrate 131 with shapes as those shown in FIG. 1 were bonded to the core block with an epoxy adhesive.

In each thin-film magnetic head assembly sample, the capacitance of the section including the thin-film magnetic head and the capacitance of the section including the base plate and the junction substrate were measured. The output of each thin-film magnetic head sample was also measured.

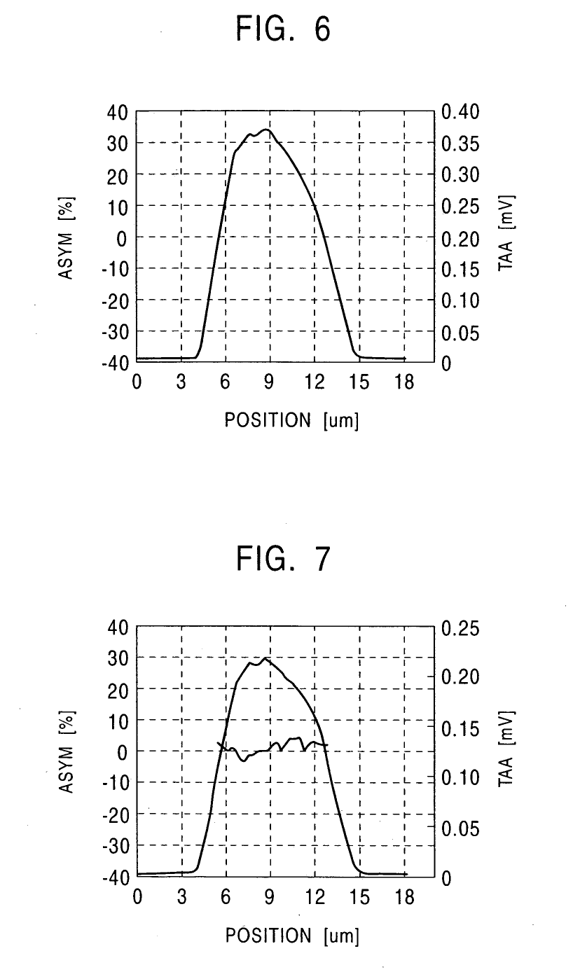

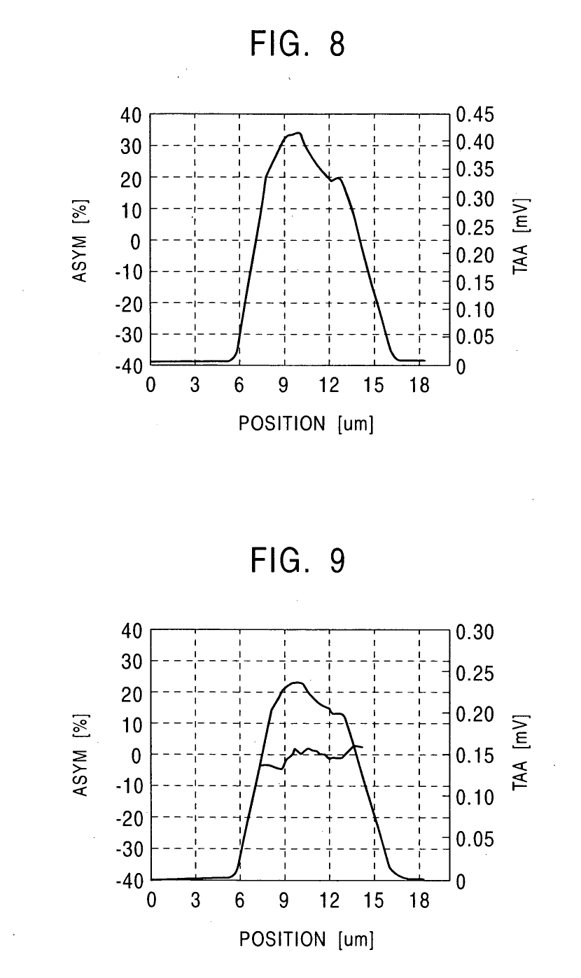

FIGS. 6 and 7 are graphs showing the measurement results of the output characteristics and the asymmetry of read output signals (symmetry of signals) according to the microtrack profile method when signals were written into a magnetic recording medium by the resultant thin-film magnetic head samples. FIGS. 8 and 9 are graphs showing the signal waveforms obtained when thin-film magnetic heads which were degraded due to electrostatic discharge were measured as in FIGS. 6 and 7.

According to the measurement results shown in FIGS. 8 and 9, although the thin-film magnetic heads were not damaged by electrostatic discharge, a large defect (a region in which the peak output was concaved) was present in the vicinity of the peak of the output waveform. The reason for this is considered that electrostatic charges were applied to the thin-film magnetic head in the production process, and abnormal current flowed into the magnetoresistive element.

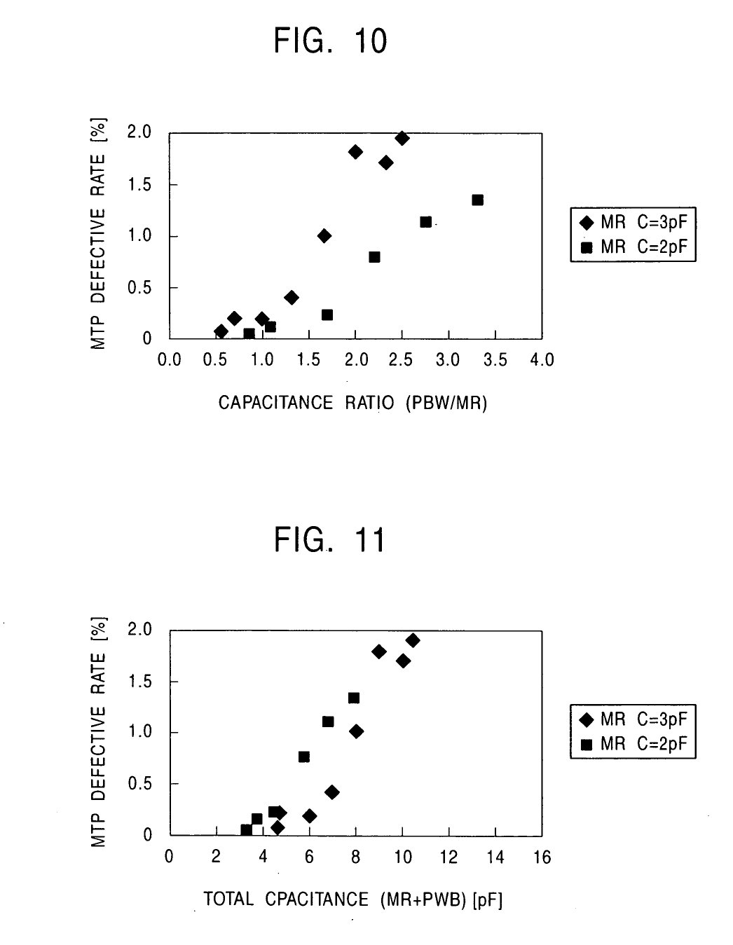

The thin-film magnetic head sample in which a normal waveform was obtained in the microtrack profile, as shown in FIG. 6 or 7, was considered to be non-defective. The thin-film magnetic head sample in which an abnormal waveform was obtained in the microtrack profile, as shown in FIG. 8 or 9, was considered to be defective. FIG. 10 is a graph showing a relationship between the microtrack profile (MTP) defective rate and the ratio of the capacitance C_{PWB} to the capacitance C_{MR}(C_{PWB}/C_{MR}) in each thin-film magnetic head assembly. Additionally, the microtrack profile method is a well-known method in which after magnetic information is written along the track with a predetermined width of a magnetic recording medium, another read head is moved so as to cross the track in the width direction to measure the strength of the output signal at predetermined positions, and thereby the signal output is analyzed.

In FIG. 10, samples with a capacitance of the thin-film magnetic head capacitance of 3 pF and samples with a thin-film magnetic head capacitance of 2 pF were measured.

As is evident from the results shown in FIG. 10, if the value C_{PWB}/C_{MR} is less than 1.5, the defective rate can be reliably decreased to 0.5% or less. Therefore, the relationship C_{PWB}/C_{MR}<1.5 is preferably satisfied.

FIG. 11 is a graph showing a relationship between the microtrack profile defective rate and the total capacitance (C_{PWB}+C_{MR}). In FIG. 11, samples with a thin-film magnetic head capacitance of 3 pF and samples with a thin-film magnetic head capacitance of 2 pF were measured.

As is evident from the results shown in FIG. 11, if the total of the capacitance C_{MR} and the capacitance C_{PWB} is 5 pF or less, the defective rate can be reliably decreased to 0.5% or less. In the thin-film magnetic head samples, the minimum of the total of the capacitance C_{MR} and the capacitance C_{PWB} was 3 pF.

Therefore, the total of the capacitance C_{MR} and the capacitance C_{PWB} is 5 pF or less, and the lower value is preferable.

In the examples described above, in order to change the capacitance of the MR element, the pattern area of the lead was decreased to approximately a half, and as the substrate, flexible printed circuit boards having different wiring areas were combined.

In the junction substrate, the area is substantially determined by the outer shape and the land size. Therefore, the capacitance can be adjusted by decreasing the area and increasing the thickness of the glass epoxy substrate itself. In the MR element, the capacitance can be adjusted by increasing the thickness of the alumina insulating layer which determines the length from the magnetic core half composed of alumina-titanium carbide to the lower shielding layer, by decreasing the area of the shielding layer, by decreasing the area of the lead, by increasing the distance from the magnetic core half composed of alumina-titanium carbide (e.g. placement of a spacer), or by other method. The low capacitances described above were achieved by adjusting the capacitances by the methods described above.

What is claimed is:

1. A thin-film magnetic head assembly comprising:
a core block provided with a sliding surface which slides over a medium, the core block comprising a magnetoresistive element disposed adjacent to an insulating layer;
a base plate on which the core block is mounted;
an insulating junction substrate mounted on at least one surface of the base plate; and
lines connecting the magnetoresistive element to terminals disposed on the junction substrate,
wherein the relationship C_{PWB}/C_{MR}<1.5 is satisfied, wherein C_{MR} is the capacitance of the core block including the magnetoresistive element, and C_{PWB} is the capacitance of a section including the junction substrate and the base plate.

2. A thin-film magnetic head assembly according to claim 1, wherein the magnetoresistive element is disposed between a plurality of insulating layers inside the core block.

3. A thin-film magnetic head assembly according to claim 1, wherein the total of the capacitance C_{MR} and the capacitance C_{PWB} is 5 pF or less.

4. A thin-film magnetic head assembly according to claim 1, wherein the total of the capacitance C_{MR} and the capacitance C_{PWB} is 1 to 5 pF.

5. A magnetic recording and playback apparatus comprising:
a thin-film magnetic head assembly according to claim 1; and
a rotary cylinder,
wherein the thin-film magnetic head assembly is mounted in a recess formed in the periphery of the rotary cylinder.

6. A thin-film magnetic head assembly according to claim 1, wherein the core block comprises:
a pair of core halves, the core halves being joined together; and
a built-in layer disposed at the junction between the core halves, the built-in layer comprising the magnetoresistive element, an electrode layer connected to the magnetoresistive element, and insulating layers or shielding layers, the insulating layers or shielding layers sandwiching the magnetoresistive element and the electrode layer,
wherein the electrode layer is connected to pads disposed outside the built-in layer, and the lines connected to the terminals of the junction substrate are connected to the pads,
wherein a capacitance is produced by the magnetoresistive element disposed between the insulating layers or shielding layers in the core block.
